(19) United States
(12) Patent Application Publication
(10) Pub. No.: US 2008/0000740 A1
(43) Pub. Date: Jan. 3, 2008

(54) Damper Structure with Silicon Layer and Manufacturing Method Thereof

(76) Inventor: Hiroshi Ohara, Taoyuang Hsien (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/423,427

(22) Filed: Jun. 9, 2006

(51) Int. Cl. F16F 7/12

(52) U.S. Cl. 188/377

(57) ABSTRACT

A damper structure with a silicone layer is provided herein, wherein the silicone layer is formed on a surface of the damper so as to be able to enhance the anti-shock performance of the damper due to the properties of silicone. A method of manufacturing a damper structure is also provided herein, which includes the steps of diluting an organic silicone varnish (TSR1122) with a diluent (xylene or toluene); catalyzing the organic silicone varnish with a catalyst (YC8108 or YC8112) to prepare a silicone material; coating the silicone material on a surface of a molded damper; and heat-curing the silicone material on the damper to form a silicone layer.

### BACKGROUND OF THE INVENTION

1. Field of the Invention

The present invention relates to a damper structure, and in particular to a damper structure with a silicone layer and a manufacturing method thereof.

2. The Prior Arts

A typical speaker includes a bass unit, a mid-range unit, and a treble unit for different audio frequencies. Most speakers work under the same mechanism. Taking a typical dynamic speaker as an example, when a voice coil of the speaker is loaded with alternating current, the current-carrying voice coil in a magnetic field of a magnet experiences a magnetic force and moves up and down in a gap, so that a cone paper attached to the voice coil moves air to produce sound.

The damper of the speaker is attached to the voice coil to stabilize the vibration of the voice coil for preventing irregular jumps and enhancing the stability of sound quality. In spite that conventional dampers are designed with a cross section of corrugated shape for providing good anti-shock performance, it will still suffer elastic fatigue after prolonged operation. Hence, it is desired to provide a damper structure with a highly resilient material to enhance the anti-shock ability of the damper.

### SUMMARY OF THE INVENTION

A primary objective of the present invention is to provide a damper structure with a silicone layer and a manufacturing method thereof, wherein the highly resilient silicone layer is additionally formed on a surface of the damper to enhance the anti-shock ability of the damper.

To achieve the above-mentioned objective, a damper structure in accordance with the present invention includes a silicone layer formed on a surface of the damper so as to enhance the anti-shock performance of the damper due to the properties of silicone. A method of manufacturing a damper structure is also provided herein, which includes the steps of diluting an organic silicone varnish (TSR1122) with a diluent (xylene or toluene); catalyzing the organic silicone varnish with a catalyst (YC8108 or YC8112) to prepare a silicone material; coating the silicone material on a surface of a molded damper; and heat-curing the silicone material on the damper to form a silicone layer.

The advantages and spirit of the present invention will be further understood by reading the following detailed description of the preferred embodiment thereof, with reference to the annexed drawings.

### BRIEF DESCRIPTION OF THE DRAWINGS

FIG. 1 is a schematic view of a speaker in accordance with the present invention; and

FIGS. 2A-2C are schematic views of dampers with a silicone layer in accordance with the present invention.

### DETAILED DESCRIPTION OF THE PREFERRED EMBODIMENT

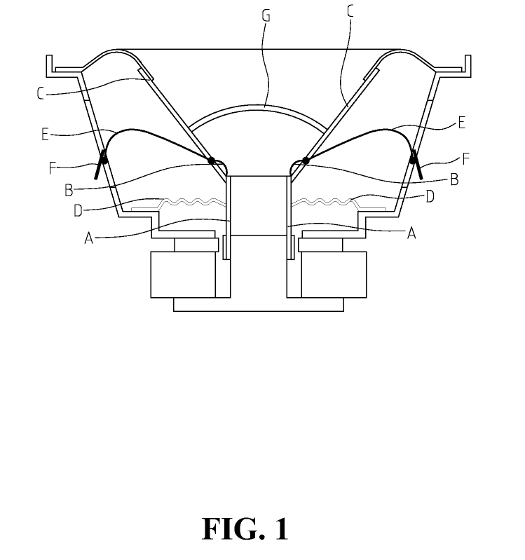

Referring to FIG. 1, a damper D with a silicone layer in accordance with the present invention is installed in a typical speaker, which includes at least a voice coil A, a voice coil wire B, a diaphragm C, a damper D, a lead wire E, a terminal F, and a dust cap G.

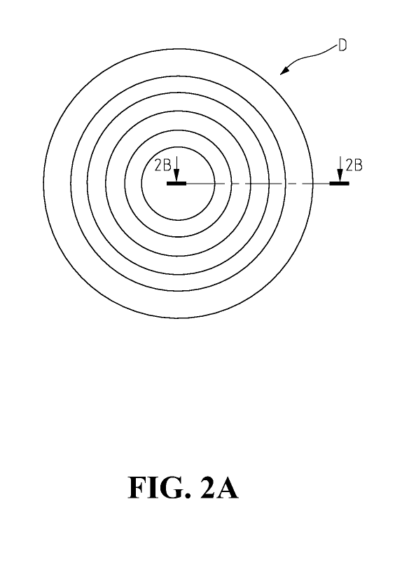

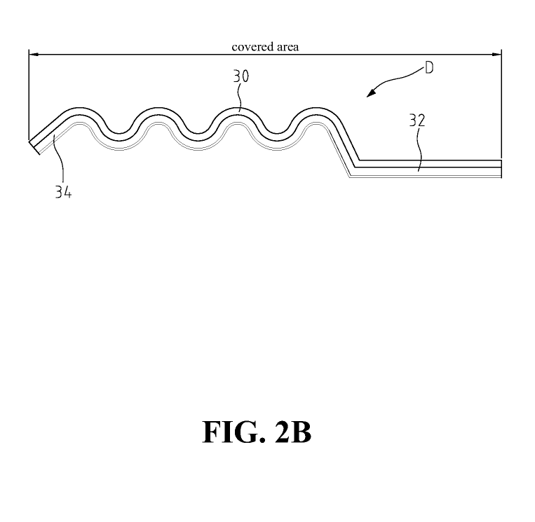

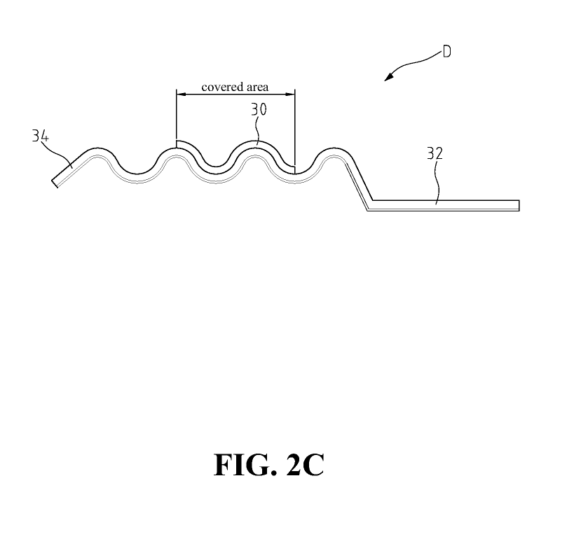

With reference to FIGS. 2A-2C, and in particular to FIG. 2A, the damper D is a ring sheet whose cross section exhibits a corrugated structure extending from its inner rim to its outer rim, as illustrated in FIGS. 2B and 2C.

To enhance the anti-shock performance of the damper, a highly resilient silicone layer 30 is additionally formed on a surface of the damper D. The silicone layer 30 is formed only covering the surface between a corrugated valley adjacent to the outer rim and a corrugated peak adjacent to the inner rim of the damper. First, a main ingredient TSR1122 of the silicone layer 30 will be briefly introduced below, and then, a method of forming the silicone layer 30 on the damper in accordance with the present invention is followed.

TSR1122 provided by GE Toshiba Silicones is an organic silicone varnish which is widely employed to manufacture organic silicone fiberglass cloth and organic silicone fiberglass sleeves. TSR1122 when mixed with other solvents forms a resilient and tough film after curing, so that the organic silicone fiberglass cloth and organic silicone fiberglass sleeve treated with TSR1122 may retain their original insulating performance after being bent repeatedly. The typical properties of TSR1122 are as follows: 30% solid content; xylene as a solvent; and xylene or toluene as a diluent. To prevent uneven pinholes, TSR1122 should be diluted with toluene/xylene to a desired solid content. The desired solid content varies depending upon application and curing conditions. In general, it is adjusted to a solid content of between 15-20%. After being completely dissolved, 2 weight parts of catalyst YC8112 or YC8108 are blended with 100 weight parts of TSR1122. The actual heat treatment condition of curing process varies depending on the base material to be treated. However, a typical curing time is done at between 140 and 160° C. for 15 to 30 minutes.

In accordance with a manufacturing method of the present invention, 1 weight part of organic silicone varnish (TSR1122) is mixed with 5 weight parts of diluent (toluene). That means that 0.02 gram of TSR1122 is added to 0.1 gram of toluene. Then 0.0012 gram of YC8108 is added to the solution to prepare a silicone material (TY105).

With reference to FIG. 2B, TY105 may be evenly coated and covered a whole surface of the molded damper D to form the silicone layer 30 or only a surface between a corrugated valley adjacent to the outer rim 32 and a corrugated peak adjacent to the inner rim 34 as shown in FIG. 2C. After coated with the corrugated layer, the damper will then be placed in a machine and baked at 210° C. for 15 to 30 seconds to form the silicone layer 30 illustrated in FIGS. 2B and 2C.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A damper structure with a silicone layer, wherein the damper is installed in a speaker which includes at least a voice coil, a voice coil wire, a diaphragm, the damper, a lead wire, a terminal, and a dust cap, and the silicone layer is formed on a surface of the damper to enhance the anti-shock performance thereof.

2. The damper structure as claimed in claim 1, wherein the damper has a corrugated cross section extending from an outer rim to an inner rim of the damper, the silicone layer is formed only covering a surface between a corrugated valley adjacent to the outer rim and a corrugated peak adjacent to the inner rim of the damper.

3. The damper structure as claimed in claim 1, wherein the silicone layer is formed covering a whole surface of the damper.

4. A method of manufacturing a damper structure with a silicone layer, comprising the steps of:
diluting an organic silicone varnish with a diluent, which is one of toluene and xylene;
catalyzing the organic silicone varnish with a catalyst to prepare a liquid silicone material;
coating the silicone material on a surface of a molded damper; and heat-curing the silicone material on the damper to form a silicone layer.

5. The method as claimed in claim 4, wherein the damper has a corrugated cross section extending from an outer rim to an inner rim of the damper, the silicone layer is formed only covering a surface between a corrugated valley adjacent to the outer rim and a corrugated peak adjacent to the inner rim of the damper.

6. The method as claimed in claim 4, wherein the silicone layer is formed covering a whole surface of the damper.
